(19) United States
(12) Patent Application Publication
(10) Pub. No.: US 2014/0074692 A1
(43) Pub. Date: Mar. 13, 2014

(54) APPLICATION OF A VALUE DATA TO A PROFILE OF A VEHICLE BASED ON A LOCATION OF THE VEHICLE

(71) Applicants: Tom Beerle, Burlingame, CA (US); Jeffrey M. Drazan, Woodside, CA (US); Brian Boling, Knoxville, TN (US)

(72) Inventors: Tom Beerle, Burlingame, CA (US); Jeffrey M. Drazan, Woodside, CA (US); Brian Boling, Knoxville, TN (US)

(73) Assignee: Spireon, Inc., Knoxville, TN (US)

(21) Appl. No.: 13/613,185

(22) Filed: Sep. 13, 2012

(51) Int. Cl. G06Q 40/00; G06F 15/173

(52) U.S. Cl. 705/39; 709/223

(57) ABSTRACT

A method, apparatus and system related to an application of a value data to a profile of a vehicle based on a location of the vehicle is disclosed. According to one embodiment, a method of an administrative server includes processing a location data of a vehicle having an onboard location device, matching the location data to a value data based on a location lookup table, and applying the value data to a profile of the vehicle. The method may include applying a credit and/or a debit, based on the value data, to an account (e.g., a financial account, a non-financial account) of a user associated with the vehicle according to a predetermined policy of an administrator. The method may also include modifying the value data to a modified value data depending on a meta-data such as a time of day, a date, and/or a vehicle type/model.

### FIELD OF TECHNOLOGY

This disclosure relates generally to global positioning technology and, more particularly, to a method, apparatus and system related to an application of a value data to a profile of a vehicle based on a location of the vehicle.

### BACKGROUND

An organization (e.g., a government entity, a company, etc.) may wish to assess a fee. The organization may also wish to issue credits to vehicle owners. For example, the organization may need to meet policy or economic goals related to vehicle usage. For example, a city may want to monetize an infrastructure investment (e.g., a bridge, a toll road, a parking garage, etc.). To do so, the city may install a physical structure at a location of the infrastructure investment. For example, the city may wish to prevent passage of a vehicle through the location until a fee is collected.

There may be liability exposure to vehicle users when physical barriers are placed at an entrance of a bridge, a toll road, a parking garage, etc. For example, the barrier may not function because of mechanical or electrical failures. The barrier may create hazards in an emergency. For example, cars may be delayed or prevented from moving past the barrier when there is a hazardous condition (e.g., fire, chemical spill, natural disaster, etc.) that threatens human lives. Even during normal operations, such physical barriers can cause traffic delays and discourage vehicle users from using the infrastructure altogether.

Construction and operation of the physical barrier also can cause liabilities for the organization. Construction of the physical barrier may cost money, require additional permits, and may interfere with and/or delay use of the infrastructure. Such interference and/or delays also may reduce the revenues that can be collected by the organization. Operation of the physical barrier may entail additional labor costs, e.g., to repair and maintain the barrier, to collect fees, for security, etc.

The barrier may be also susceptible to theft and physical damage from a variety of sources (e.g. natural damage, vehicle collisions, vandalism, etc.) In addition, assessing fees from individual vehicles at the physical barrier and/or elsewhere (e.g., based on miles driven) may be highly inefficient for the purposes of compiling data across many vehicles and across many infrastructure sites. Manual collection of data may be an impractical solution to meet policy goals (e.g. emissions reductions, reducing traffic congestion) that are not site specific, but relate to more general vehicle usage patterns.

### SUMMARY

Disclosed are a method, an apparatus and/or a system to use vehicle location data for assessment of fees and other purposes.

A method and a system related to an application of a value data to a profile of a vehicle based on a location of the vehicle are disclosed. In one aspect, a method of an administrative server includes processing a location data of a vehicle having an onboard location device, matching the location data to a value data based on a location lookup table, and applying the value data to a profile of the vehicle. The method may further include applying a credit and/or a debit (based on the value data) to an account (e.g., a financial account, a non-financial account) of a user associated with the vehicle. The credit and/or the debit may be applied according to a predetermined policy of an administrator.

The method may also involve modifying the value data to a modified value data. The modification may depend on a meta data comprising a time of day, a date, a vehicle type, a vehicle model, a vehicle manufacturer, a property associated with the location, a network associated with the location, a total of usage of the vehicle during a predetermined period of time, a total of carbon emissions calculated for the vehicle during a predetermined period of time, a usage pattern of the vehicle, a network associated with a user of the vehicle, a profile associated with a user of the vehicle, a number of passengers associated with the vehicle, a level of a benefits plan associated with a user, an account balance associated with a user, an occupancy data associated with the site, and/or an occupancy data associated with sites associated with the network.

The method may further include communicating (e.g., in real-time) the modified value data to a display device associated with the vehicle. The method may present a view of the modified value data to the user associated with the vehicle. The method may combine a modified value data associated with a predetermined set of vehicles into an aggregate vehicle data. In addition, the method may combine the modified value data associated with a predetermined set of locations into an aggregate location data. The modified value data associated with a predetermined set of users may be combined into an aggregate user data. A report may be generated based on the processing the aggregate vehicle data, the aggregate location data and/or the aggregate user data. An administrative task may be implemented based on the aggregate vehicle data, the aggregate location data and/or the aggregate user data.

In another aspect, a method of an onboard location device includes processing a location data at the onboard location device associated with a vehicle, and rendering the location data and the value data in a display of the vehicle based on a match of the location data and a value data in a location lookup table of an administrative server.

In yet another aspect, a system includes an administrative server, an onboard location device, and a selection module. The administrative server processes a location data of a vehicle. The onboard location device transmits the location data of the vehicle to the administrative server. The selection module of the administrative server matches the location data to a value data (e.g., based on a location lookup table). The administrative server also applies the value data to a profile of the vehicle.

The system may also include a financial transaction module of the administrative server to apply a credit and/or a debit, based on the value data, to the account of a user associated with the vehicle. The financial transaction module may apply the credit according to a predetermined policy of an administrator.

The system may also comprise a value adjustment module to modify the value data to a modified value data depending on the meta data. The system may also include an administrative server that communicates, in real-time, a modified value data to a display device associated with the vehicle and presents a view of the modified value data to a user associated with the vehicle.

The system may also contain an aggregation module which may combine a modified value data associated with a predetermined set of vehicles into an aggregate vehicle data. The aggregation module may also combine the modified value data associated with a predetermined set of locations into an aggregate location data. In addition, the modified value data associated with a predetermined set of users may be combined into an aggregate user data. The aggregation module may also generate a report based on the processing of the aggregate vehicle data, the aggregate location data, and/or the aggregate user data.

In a further aspect, a method includes generating a set of geospatial boundaries associated with a region of interest, applying a set of rules to the geospatial boundary associated with the region of interest, assessing a value data to a vehicle having an onboard location device when the vehicle traverses the region of interest, and applying the value data to a profile of the vehicle. The method may include processing a location data of the vehicle having the onboard location device. Moreover, the method may determine that the location data is in the set of geospatial boundaries associated with the region of interest.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

FIG. 1 is a schematic view of a vehicle 102 configured to transmit location data 120 through an onboard location device 106 to an administrative server 100 having a set of modification rules 114 in a database, according to one embodiment.

FIG. 2 is a detail view of the administrative server 100 of FIG. 1 applying a credit 200 and/or a debit 202 to an account of a user 124, according to one embodiment.

FIG. 3 is a schematic view of a meta data 300 applied to a value data 122 in the administrative server 100 based on the modification rules 114 in the database of FIG. 1, according to one embodiment.

FIG. 4 is a user 124 interface view in which the vehicle 102 of FIG. 1 displays the value data 122 in a display device 400 when the value data 122 is modified with the modification rules 114, according to one embodiment.

FIG. 5 is a schematic view that illustrates how information from the administrative server 100 of FIG. 1 is processed by the vehicle 102 so that it may be displayed in the display device 400 of the vehicle 102 as described in FIG. 4, according to one embodiment.

FIG. 6 is a schematic view that illustrates a network 104 in which a number of vehicles communicate their locations to the administrative server 100 of FIG. 1 having an aggregate location data 600, an aggregate user data 602, and an aggregate vehicle data 604, according to one embodiment.

FIG. 7 is a set of modules that are used to perform functions of the administrative server 100 of FIG. 1, according to one embodiment.

FIG. 8 is a process flow of applying the value data 122 to a profile 118 of the vehicle 102 of FIG. 1, according to one embodiment.

FIG. 9 is a regional view illustrating a set of geo-spatial boundaries around a region of interest 900 in which the vehicle 102 of FIG. 1 traverses, according to one embodiment.

FIG. 10 is a user 124 interface view of the administrative server 100 of FIG. 1, according to one embodiment.

FIG. 11 is a table view of the administrative server 100 of FIG. 1, according to one embodiment.

### DETAILED DESCRIPTION

Example embodiments, as described below, may be used to provide a method, a system and/or an apparatus of using vehicle location data for assessment of fees and other purposes, according to one or more embodiments. Although the present embodiments have been described with reference to specific example embodiments, it will be evident that various modifications and changes may be made to these embodiments without departing from the broader spirit and scope of the various embodiments.

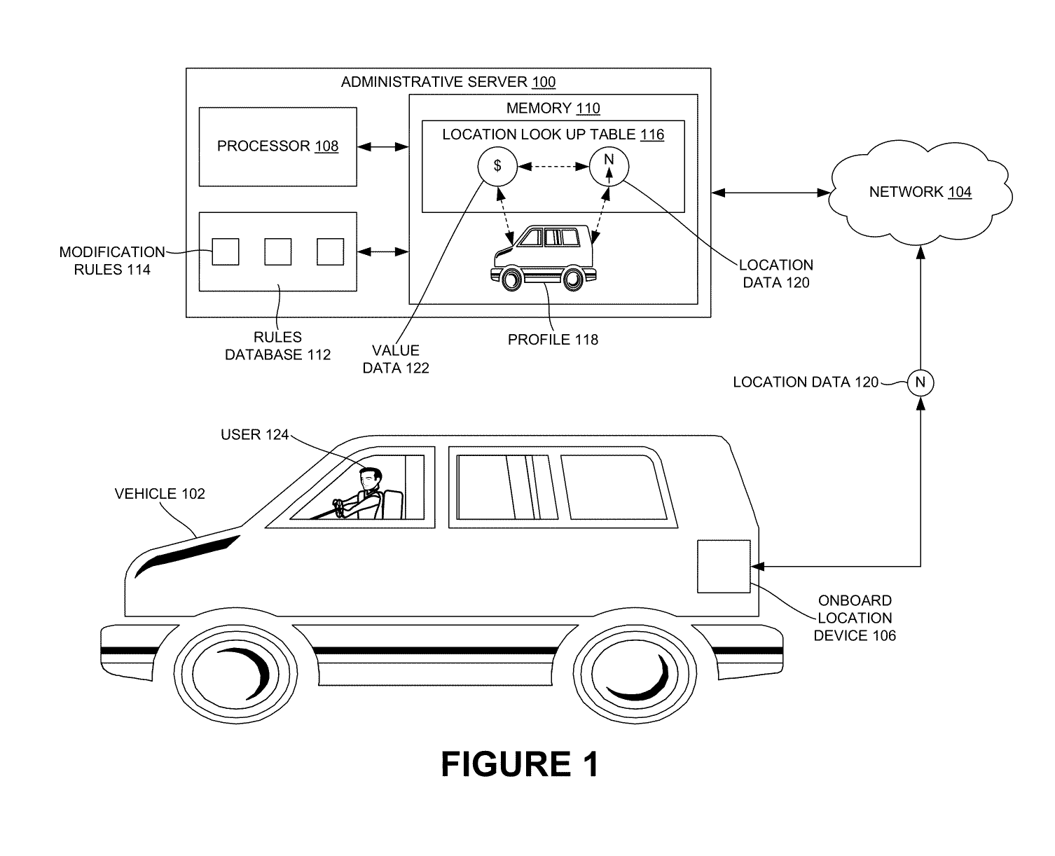

FIG. 1 is a schematic view of a vehicle 102 configured to transmit location data 120 through an onboard location device 106 to an administrative server 100 having a set of modification rules 114 in a database, according to one embodiment. FIG. 1 illustrates the administrative server 100 communicating with the vehicle 102 through a network 104. The vehicle 102 includes the onboard location device 106. The administrative server 100 includes a processor 108, a memory 110, and a rules database 112. The rules database 112 includes a set of modification rules 114. The memory 110 also includes a location lookup table 116, and a profile 118. The location lookup table 116 comprises a location data 120 and a value data 122. A user 124 is illustrated in FIG. 1 as a driver of the vehicle 102.

The location data 120 is communicated between the onboard location device 106 of the vehicle 102 and the administrative server 100. The administrative server 100 may be a data processing system that includes a set of hardware and software components that aid the administrative server 100 in the management, coordination, and execution of the various methods described herein. The administrative server 100 may be operated by an organization (e.g. a government, car company, insurance company, non-profit, etc.) or an individual that has an interest in collecting information about vehicle 102 usage and carrying out tasks based on that information. In one or more embodiments, the administrative server 100 is run by a third party, on behalf of one or more organizations.

The vehicle 102 may be an automobile, a motorcycle, a bicycle, a boat, a truck, a train, a bus and/or any other type of ground transportation movable carrier. The network 104 may be an Internet, and/or any other type of Wide Area Network (WAN) capable of facilitating communications between the administrative server 100 and the vehicle 102. The network 104 may enable communication through a wired and/or wireless network. The onboard location device 106 may be a global positioning system installed within the vehicle 102 and/or a cellular triangulation system that aids in the geospatial identification of a past, a present, and/or a future location of the vehicle 102.

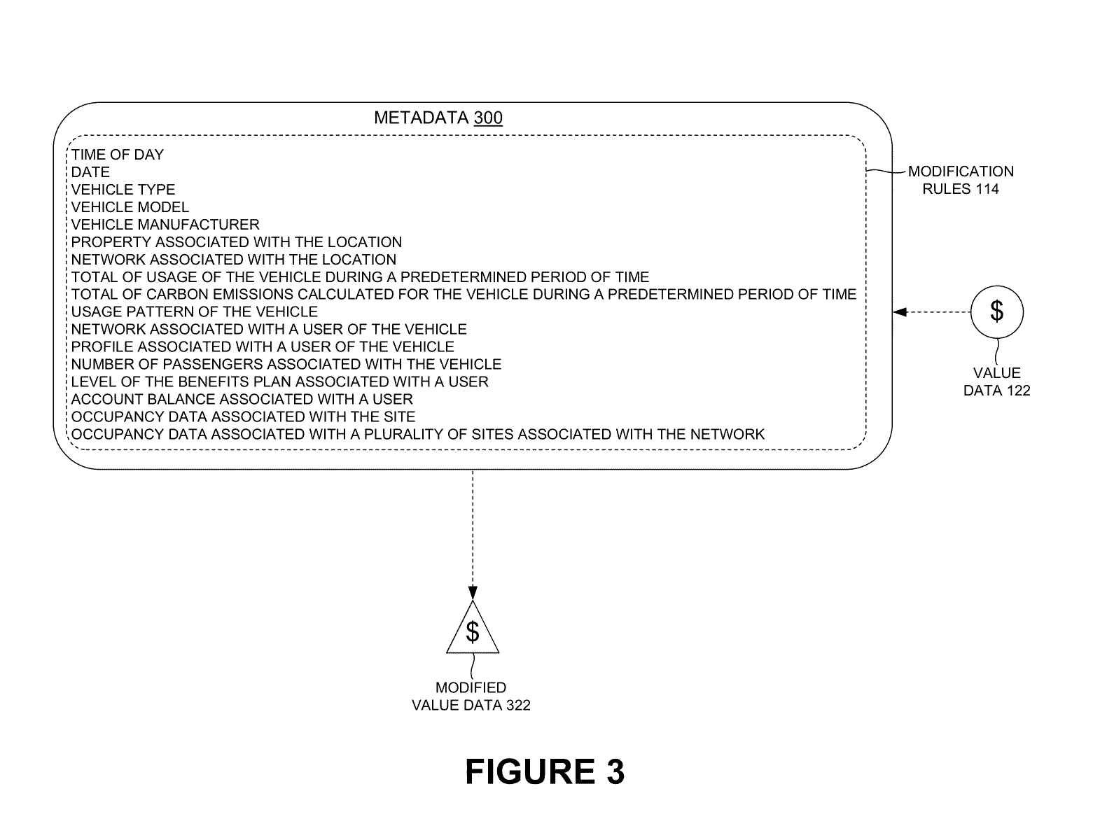

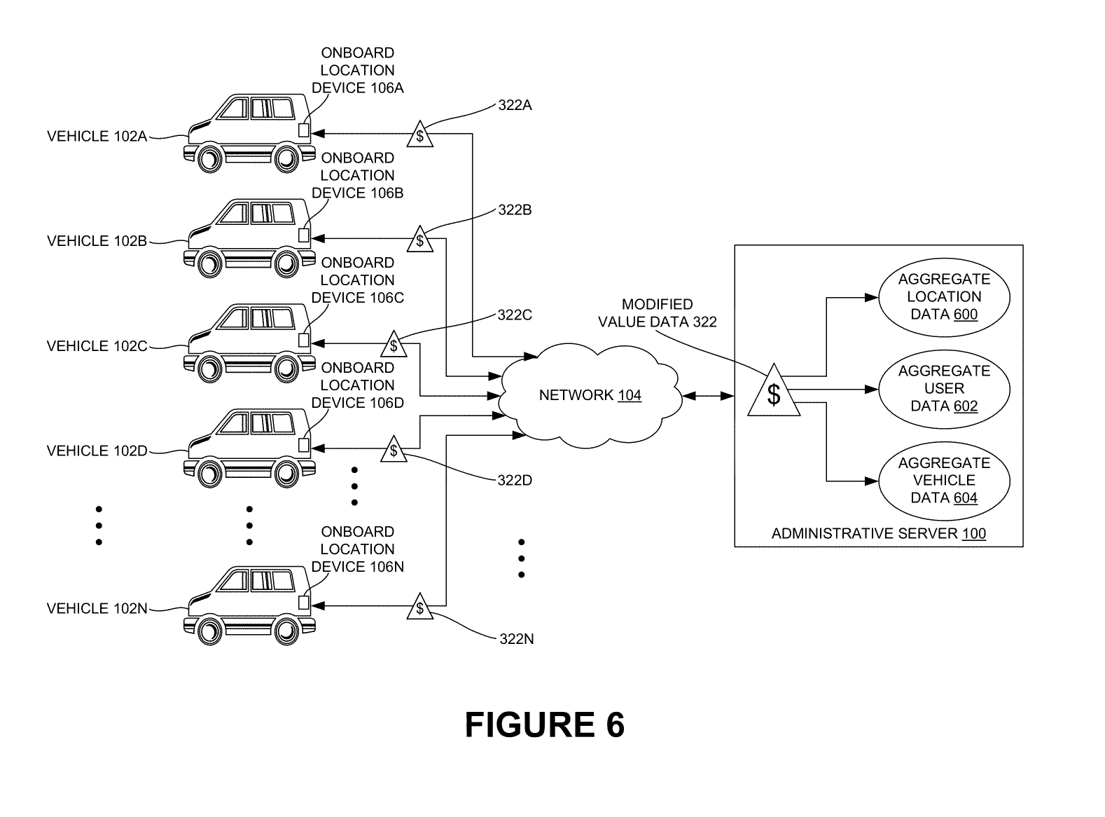

The processor 108 may be an integrated circuit designed to permit the administrative server 100 to communicate with the vehicle 102 and other vehicles as shown in FIG. 6. The memory 110 may be a random access memory through which various commands are executed from a storage device (not shown) associated with the administrative server 100. The rules database 112 may be in the storage device and communicatively coupled with the processor 108 and the memory 110. The rules database 112 may house a set of records, fields, and tables, associated with a set of modification rules 114. The modification rules 114 are described in relation to FIG. 3. The modification rules 114 may be applied as a meta data 300 as described in FIG. 3.

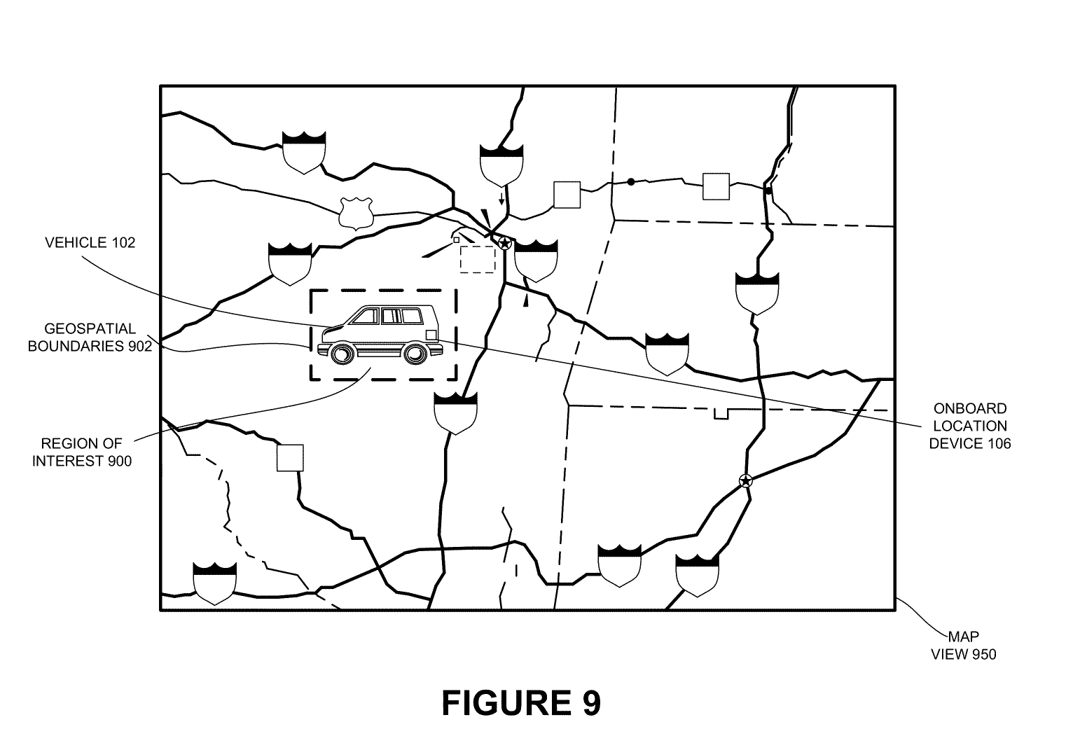

Particularly, FIG. 3 is a schematic view of a meta data 300 applied to a value data 122 in the administrative server 100 based on the modification rules 114 in the database of FIG. 1, according to one embodiment. FIG. 3 illustrates a meta data 300 that is applied to the value data 122 to create the modified value data 322. The meta data 300 may include the set of modification rules 114. Particularly, the meta data 300 may include modification rules 114 including rules such as determining when and what type of vehicle is monitored in a region of interest 900 as shown in FIG. 9. The method may also involve modifying the value data 122 to a modified value data 322.

The modification may depend on a meta data 300 comprising a time of day, a date, a vehicle type, a vehicle model, a vehicle manufacturer, a property associated with the location, a network 104 associated with the location, a total of usage of the vehicle 102 during a predetermined period of time, a total of carbon emissions calculated for the vehicle 102 during a predetermined period of time, a usage pattern of the vehicle 102, a network 104 associated with a user 124 of the vehicle 102, a profile associated with a user 124 of the vehicle 102, a number of passengers associated with the vehicle 102, a level of a benefits plan associated with a user 124, an account balance associated with a user 124, an occupancy data associated with the site, and/or an occupancy data associated with sites associated with the network 104.

Referring now to FIG. 1, a location look up table 116 may be used by the administrative server 100 to determine whether the vehicle 102 is presently within the region of interest 900 as shown in FIG. 9. Information in a location look up table 116 may be matched with a location data 120 of the vehicle 102 such that it may correspond with a particular value data 122. The location data 120 may include information about a present geospatial location of the vehicle 102. The value data 122 may determine what type of action is required when the vehicle 102 is in the region of interest 900 of FIG. 9.

The profile 118 may associate an electronic record of events associated with the vehicle 102. For example, the profile 118 may inform who is an owner of the vehicle, what the identification information is of the owner of the vehicle 102, and which types of location data 120 and value data 122 are to be applied to the vehicle 102 in light of a past, current, or future location of the vehicle 102. For example, if the vehicle is on a bridge, a municipality may charge a toll automatically to the user 124 of the vehicle 102 when the onboard location device 106 communicates a present geospatial location (e.g., the location data 120) to the administrative server 100.

In one example, a method of the administrative server 100 includes processing a location data 120 of a vehicle 102 having an onboard location device 106. The location data 120 is matched to a value data 122 based on a location lookup table 116. The value data 122 is applied to a profile 118 of the vehicle 102, according to one embodiment.

In another example, a method of an onboard location device 106 includes processing a location data 120 at the onboard location device 106 associated with a vehicle 102, and rendering the location data 120 and the value data 122 in a display of the vehicle 102 based on a match of the location data 120 and a value data 122 in a location lookup table 116 of an administrative server 100.

FIG. 1 shows a vehicle 102 configured to transmit location data 120 thereof, according to one or more embodiments. In one or more embodiments, vehicle 102 may include an onboard location device 106 mounted therein, to determine a location data 120 associated with the vehicle 102 and to communicate with an administrative server 100 (e.g., an entity providing administrative services, an Original Equipment Manufacturer (OEM)). Administrative server 100 includes a memory 110 and a processor 108 to process incoming location data 120 along with stored value data 122 (e.g. highway toll amount, bridge toll, usage fees of the vehicle 102, airline mileage credits, etc.) and to carry out tasks based on the data.

In one or more embodiments, administrative server 100 may be configured to receive location data 120 of vehicle 102 at various points in time and store the aforementioned data in memory 110. For example, onboard location device 106 of vehicle 102 may transmit location data 120 on a periodic basis (e.g., once every minute, once every hour, once every day). In another example, onboard location device 106 of vehicle 102 may transmit location data 120 whenever a condition (e.g., vehicle 102 passing a predetermined location; locations may be delimited by geospatial coordinates, vehicle 102 staying put at the same geographical location beyond a threshold time period; vehicle 102 traveling a certain distance, vehicle 102 following a predetermined usage pattern) is met.

In one or more embodiments, onboard location device 106 may be a Global Position System (GPS) enabled device. In one or more embodiments, administrative server 100 may include a processor 108 communicatively coupled to a memory 110. Here, processor 108 may be configured to address storage locations in memory 110 (e.g., a volatile memory), and may be configured to execute instructions (e.g., stored in memory 110) associated with various kinds of data (e.g. location data 120, value data 122).

In one or more embodiments, administrative server 100 may communicate with vehicle 102 through a network 104. In one or more embodiments, network 104 may be a mobile network or a Wide Area Network (WAN). The various embodiments in the Figures show an administrative server 100, according to one or more embodiments. In one or more embodiments, memory 110 may include location lookup table 116, which stores, among other information, the correlation between location data 120 and its matching value data 122. In one or more embodiments, memory 110 may be configured to store location data 120 associated with vehicle 102. In one or more embodiments, memory 110 may also include instructions executable through processor 108. The aforementioned instructions may be associated with processes such as analyzing location data 120 to assign value data 122, aggregating data across vehicles, locations and/or time and carrying out tasks associated with the data. The various Figures serve to present administrative server 100 as performing the analysis and carrying out of tasks merely as an example. Alternatively, administrative server 100 may be a network 104 of individual servers configured to perform one or more functions such as determining value data 122 and/or data analysis as a collective unit.

The value data 122 may take many different forms. For example, value data 122 may be toll charges to be applied to vehicle 102 when it passes a predetermined location the location, such as a bridge, a toll highway, entrance to an amusement park. In one or more embodiments, value data 122 may be credits assigned to vehicle 102 for passing certain locations (e.g. the commercial locations of a particular retailer, real estate listings, points on a treasure hunt, etc.) In yet another embodiment, value data 122 may be a cost function applied to the usage of vehicle 102 or applied to a predetermined set of vehicles. Other scenarios in which the value data 122 represents a function of the location data 120 associated with vehicle 102 are within the scope of the exemplary embodiments.

In one embodiment, the location data 120 of the vehicle 102 is determined primarily by the onboard location device 106 in conjunction with a global position system (GPS). In this embodiment, the onboard location device 106 communicates the location data 120 of the vehicle 102 to the administrative server 100 through a space-based satellite navigation system that provides location data 120 and time information in all weather conditions, anywhere on or near the Earth, where there is an unobstructed line of sight to at least a minimum number of GPS satellites (e.g., four satellites).

In other words, the onboard location device 106 may serve as a GPS transceiver, which determines a present location of the vehicle 102 through the space-based satellite navigation system, and communicates that location of the vehicle 102 externally to the administrative server 100. The onboard location device 106 may use the messages received by the onboard location device 106 from the space-based satellite navigation system to determine a transit time of each message. The onboard location device 106 may compute a distance to each satellite at a speed of light. These distances along with the satellites' locations may be used by the onboard location device 106 with the possible aid of trilateration, depending on which algorithm is used, to compute a position of the vehicle 102.

In one embodiment, four or more satellites may be visible to obtain an accurate location of the vehicle 102. In another embodiment, the onboard location device 102 may determine a location of the vehicle 102 with only three satellites, when the vehicle 102 and/or the onboard location device 106 are configured with an extremely precise clock. Alternatively, when a cellular triangulation method is used by the onboard location device 106 to determine the location of the vehicle 102, a multi-lateration of radio signals technique may be used which emit a roaming signal to communicate with a next nearby antenna tower (e.g. may not require an active call).

There are many reasons that an organization or individual may wish to collect location data 120 of a vehicle 102 and associate it with value data 122. For example, a state may wish to estimate vehicle emissions from vehicle 102 and to assess a fee related to the quantity of emissions, in order to reduce emissions according to policy targets. In another example, a company may wish to award credits to customers who visit their retail locations. Such credits could then be redeemed, for example, with discounts on products, prizes or special privileges. In another example, a company administering parking garages may use the data to calculate occupancy at one or more garage locations, and may communicate dynamic information to customers (e.g. increased or decreased parking costs, occupancy information, alternate parking options, etc.) that depends on the data collected.

In one or more embodiments, onboard location device 106 may have a communication device through which signals may be received from and sent to administrative server 100 through network 104. The communications may include location data 120, value data 122, dynamic changes to be applied to value data 122, instructions for the onboard location device 106 (e.g. to turn on or off the onboard location device 106, to communicate with user 124 associated with vehicle 102, to change the frequency and/or parameters of collecting location data 120, to change the frequency and/or parameters of communicating location data 120, etc.), and other information that may be used in carrying out the policy or economic goals of the administrator.

In one or more embodiments, onboard location device 106 may also include a value module including a processor 108 communicatively coupled to a memory 110, where memory 110 may have a location lookup table 116 storing value data 122 correlated with particular locations stored. In one or more embodiments, location data 120 may be made available to administrative server 100 either all the time or on a conditional basis. In one or more embodiments, a government or policy of the administrator may dictate that location data 120 be made available to the administrative server 100 only under limited conditions (e.g. vehicle 102 entering a specified location zone).

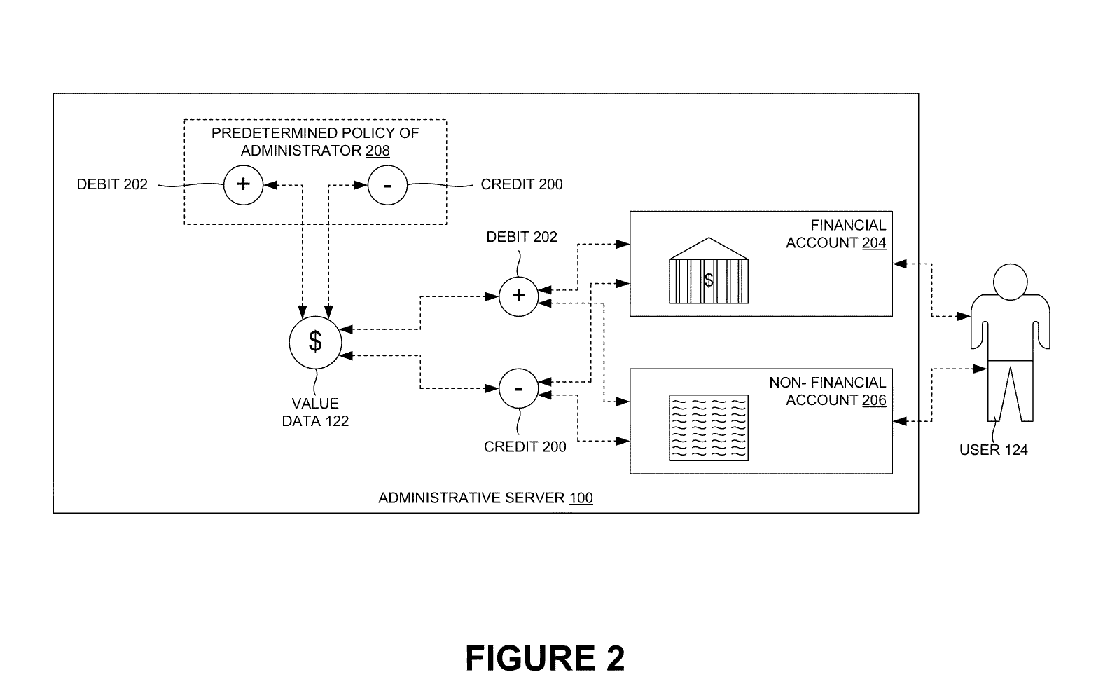

FIG. 2 is a detail view of the administrative server 100 of FIG. 1 applying a credit 200 and/or a debit 202 to an account of a user 124, according to one embodiment. The method may further include applying a credit 200 and/or a debit 202 (based on the value data 122) to an account (e.g., a financial account 204, a non-financial account 206) of a user 124 associated with the vehicle 102. A credit 200 and/or debit 202 may be a specific monetary amount that is determined by a combination of a policy of the administrator and the value data 122 based on the location data 120. For example, the administrative server 100 may utilize the value data 122 to determine whether a credit 200 and/or debit 202 may be applied to an account of a user 124 of a vehicle 102, particularly when the vehicle 102 exits or enters the region of interest 900.

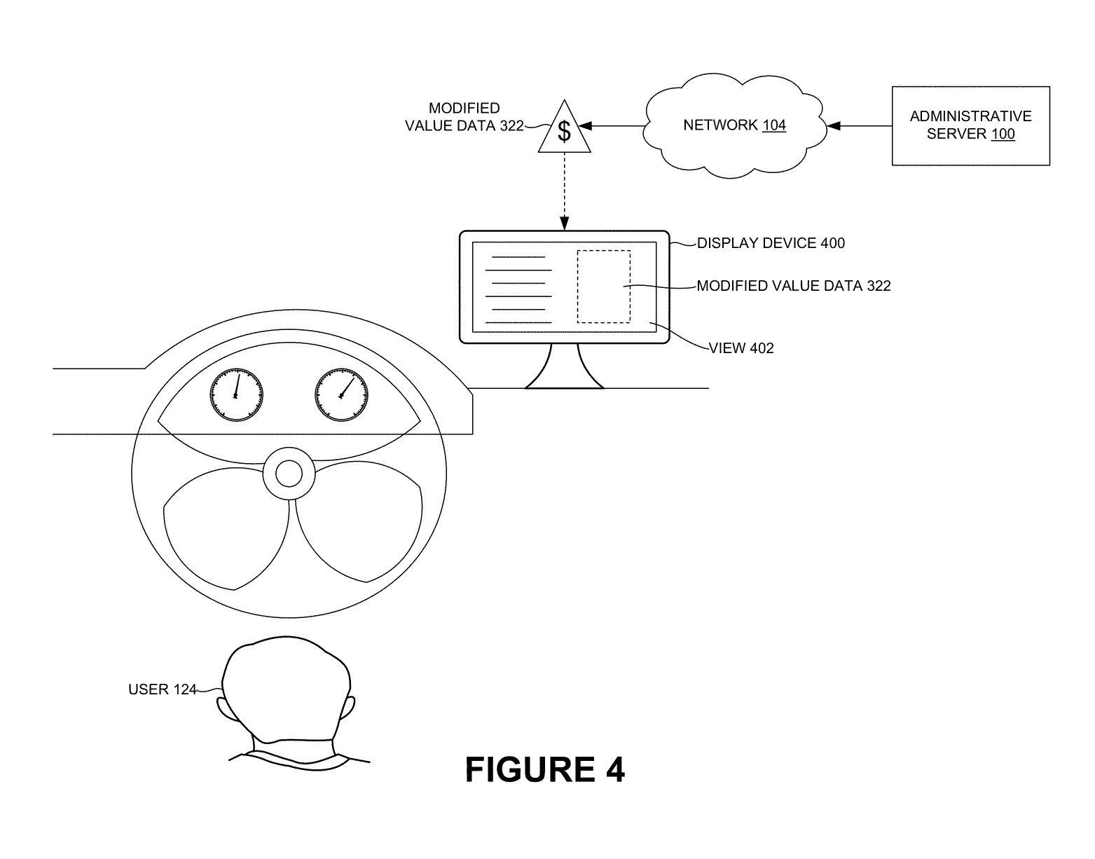

FIG. 4 is a user interface view in which the vehicle 102 of FIG. 1 displays the value data 122 in a display device 400 as a view 402 when the value data 122 is modified with the modification rules 114, according to one embodiment. The method may further include communicating (e.g., in real-time) the modified value data 322 to a display device 400 associated with the vehicle 102. In one example, the administrative server 100 may relay the modified value data 322 over a network 104 and to a display device 400. The display device 400 may be located in the vehicle 102 such that user 124 may view the modified value data 322. The display device 400 may include a liquid crystal display (LCD) or light-emitting diode display (LED) to depict the modified value data 322 as text and/or images. The modified value data 322 presented on the display device 400 may include information pertaining to the location of the vehicle 102 with regard to a geospatial boundaries 902. For example, the display device 400 may present the credit 200 and/or debit 202 amount that is applied to an account (e.g., a financial account 204, a non-financial account 206) of a user 124 based on the location of the user 124 in a region of interest 900. The display device 400 may also list details in text format regarding the location of the vehicle 102, such as the regions of interest 900 in which the vehicle 102 has traversed within a set period of time. The display device 400 may also depict an image of a map that may indicate the current location of the vehicle 102 with regard to a region of interest 900 and the geospatial boundaries 902.

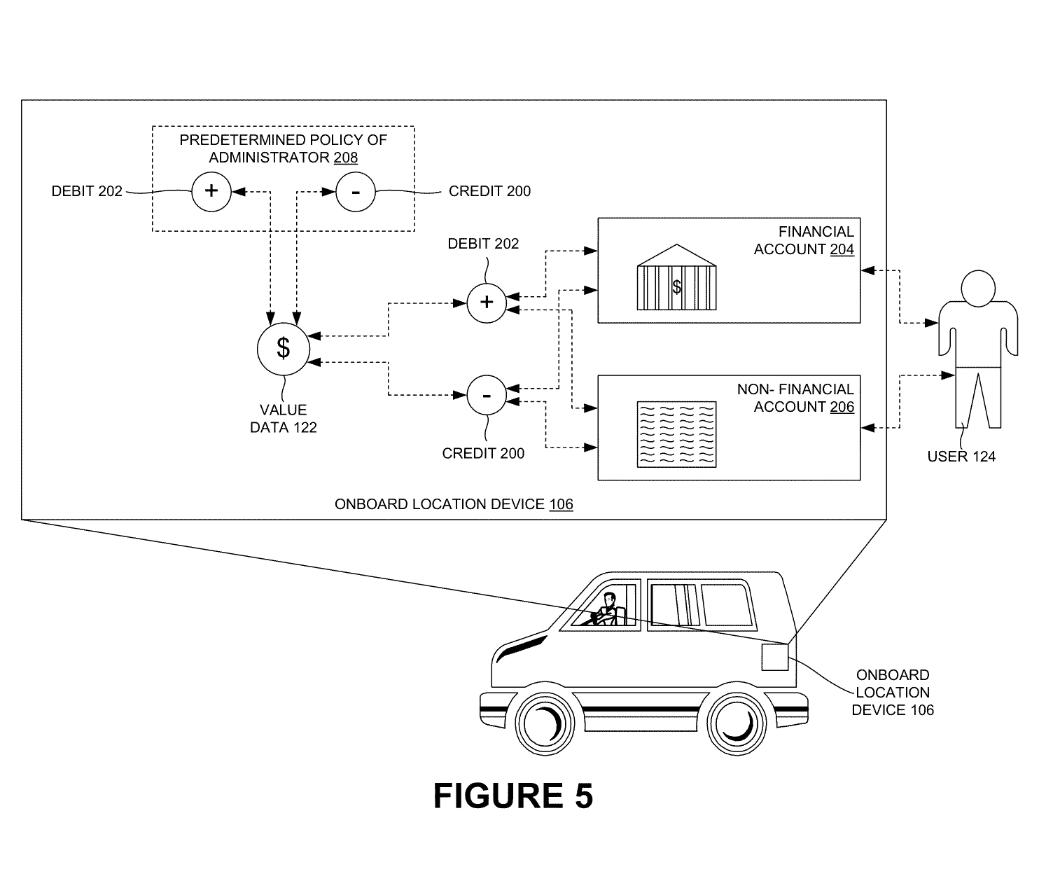

FIG. 5 is a schematic view that illustrates how information from the administrative server 100 of FIG. 1 is processed by the onboard location device 106 of vehicle 102 so that it may be displayed in the display device 400 of the vehicle 102 as described in FIG. 4, according to one embodiment. The onboard location device 106 processes location data 120 according to the location of the vehicle 102. Accordingly, the onboard location device 106 may utilize the location data 120 to initiate the application of a credit 200 and/or a debit 202 to an account of a user 124 of vehicle 102. The credit 200 and/or debit 202 amount may be established according to a predetermined policy of administrator 208 and the value data 122. The information processed by the onboard location device 106 of the vehicle 102 may be sent through a network 104 to an administrative server 100, as shown in FIG. 6.

FIG. 6 is a schematic view that illustrates a network 104 in which a number of vehicles communicate the modified value data 322 to the administrative server 100 of FIG. 1 having an aggregate location data 600, an aggregate user data 602, and an aggregate vehicle data 604, according to one embodiment. The method may combine the modified value data 322 associated with a predetermined set of locations into an aggregate location data 600. The method may also combine a modified value data 322 associated with a predetermined set of vehicles into an aggregate vehicle data 604. In addition, the modified value data 322 associated with a predetermined set of users may be combined into an aggregate user data 602. For example, the aggregate location data 600 may be a compilation of the location data 120 of a plurality of vehicles (e.g. vehicle 102A, vehicle 102B . . . vehicle 102N). The location data 120 of the plurality of vehicles may be extracted from the modified value data (e.g. 322A, 322B . . . 322N) by the administrative server 100.

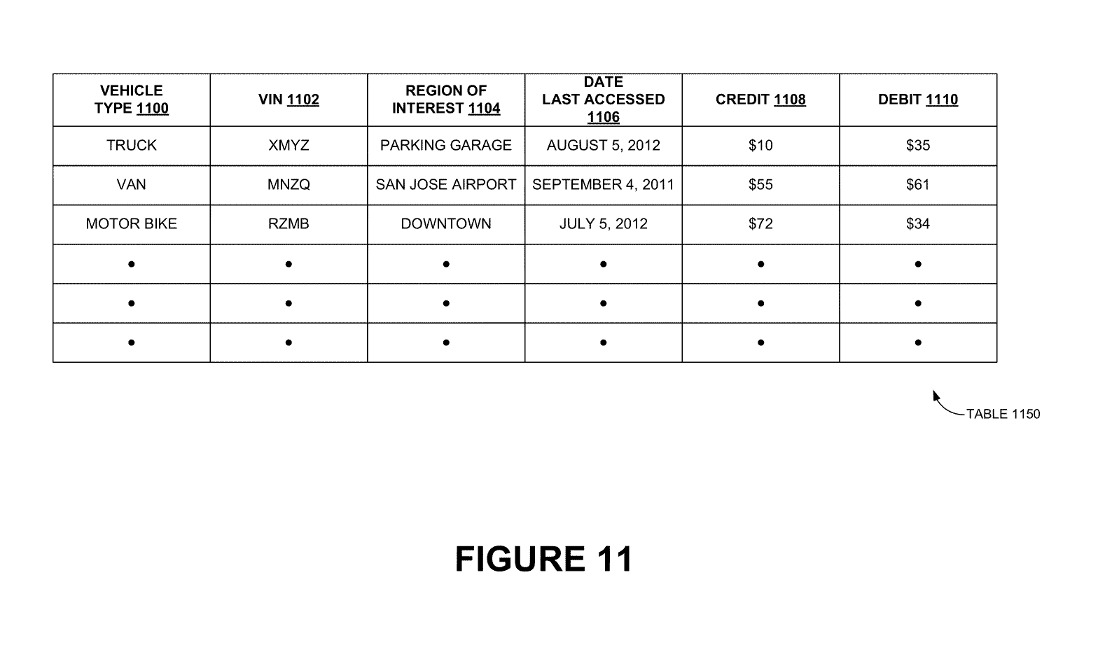

In another example, the aggregate user data 602 may be a compilation of data regarding the users of a plurality of vehicles (e.g. vehicle 102A, vehicle 102B . . . vehicle 102N). The user data of the plurality of vehicles may be extracted from the modified value data (e.g. 322A, 322B . . . 322N) by the administrative server. In yet another example, the aggregate vehicle data 604 may be a compilation of vehicle data of a plurality of vehicles (e.g. vehicle 102A, vehicle 102B . . . vehicle 102N). The aggregate vehicle data 604 may also be extracted from the modified value data (e.g. 322A, 322B . . . 322N) by the administrative server. Furthermore, a report may be generated based on a processing of the aggregate vehicle data 604, the aggregate location data 600 and/or the aggregate user data 602. For example, the aggregate vehicle data 604, aggregate location data 600 and/or the aggregate user data 602 may be compiled into a table, as shown in FIG. 11.

Particularly, FIG. 11 is a table view of the administrative server 100 of FIG. 1, according to one embodiment. The table may be presented to an administrator and/or personnel who may have access to the information stored and/or processed on the administrative server 100. In one example, the table may list the aggregate vehicle data 604, the aggregate location data 600, and/or the aggregate user data 602 compiled by the administrative server 100. The aggregate vehicle data 604 may include information regarding vehicle type 1100 (e.g. truck, van, motorbike, etc.) and/or vehicle identification number (VIN 1102). The table may also list a date last accessed 1106, in which the date represents a day, month, and year of when the region of interest 1104 was last accessed by a particular vehicle. The table may also present a credit 1108 and/or debit 1110 amount correlating to a region of interest 1104 and/or a VIN 1102. For example, the table may display that a van with a VIN 1102 of MNZQ accessed the San Jose Airport last on Sep. 4, 2011 and has credit 1108 in the amount of $55 and debit 1110 in the amount of $61.

Referring now to FIG. 6, an administrative task may be implemented based on the aggregate vehicle data 604, the aggregate location data 600 and/or the aggregate user data 602. For example, an administrative task may involve meeting certain economic (e.g. charging for the use of infrastructure) or policy (e.g. reducing carbon emissions, reducing smog) goals.

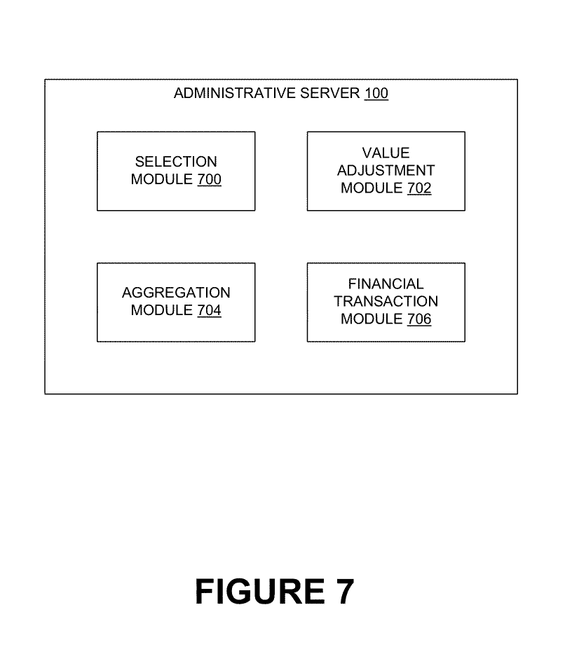

FIG. 7 is a set of modules that are used to perform functions of the administrative server 100 of FIG. 1, according to one embodiment. In one embodiment, the administrative server 100 may comprise a selection module 700, a value adjustment module 702, an aggregation module 704, and/or a financial transaction module 706. The selection module 700 of the administrative server 100 matches the location data 120 to a value data 122 (e.g., based on a location lookup table 116). The selection module 700 also applies the value data 122 to a profile 118 of the vehicle 102.

The administrative server 100 may also comprise a value adjustment module 702 to modify the value data 122 to a modified value data 322 depending on the modification rules 114 of the meta data 300. The administrative server 100 may also include an aggregation module 704 which may combine a modified value data 322 associated with a predetermined set of vehicles into an aggregate vehicle data 604. The aggregation module 704 may also combine the modified value data 322 associated with a predetermined set of locations into an aggregate location data 600. In addition, the modified value data 322 associated with a predetermined set of users may be combined by the aggregation module into an aggregate user data 602. The aggregation module 704 may also generate a report based on the processing of the aggregate vehicle data 604, the aggregate location data 600, and/or the aggregate user data 602.

Modification may refer to a transformation in which a value data is changed based on a criteria. For example, the criteria may be set by a municipality that a controls access to a bridge. Those vehicles which are heavier (e.g., trucks) may pay a larger toll than those vehicles which have desirable characteristics (e.g., electric cars). Similarly, the municipality may modify the value data such that the tolls may be more expensive during peak driving hours.

The financial transaction module 706 of the administrative server 100 may apply a credit 200 and/or a debit 202, based on the value data 122, to the account of a user 124 associated with the vehicle 102. The financial transaction module 706 may apply the credit 200 and/or debit 202 according to a predetermined policy of an administrator 208.

In another embodiment, a system includes an administrative server 100, comprising of a selection module 700, a value adjustment module 702, an aggregation module 704, and a financial transaction module 706, and an onboard location device 106.

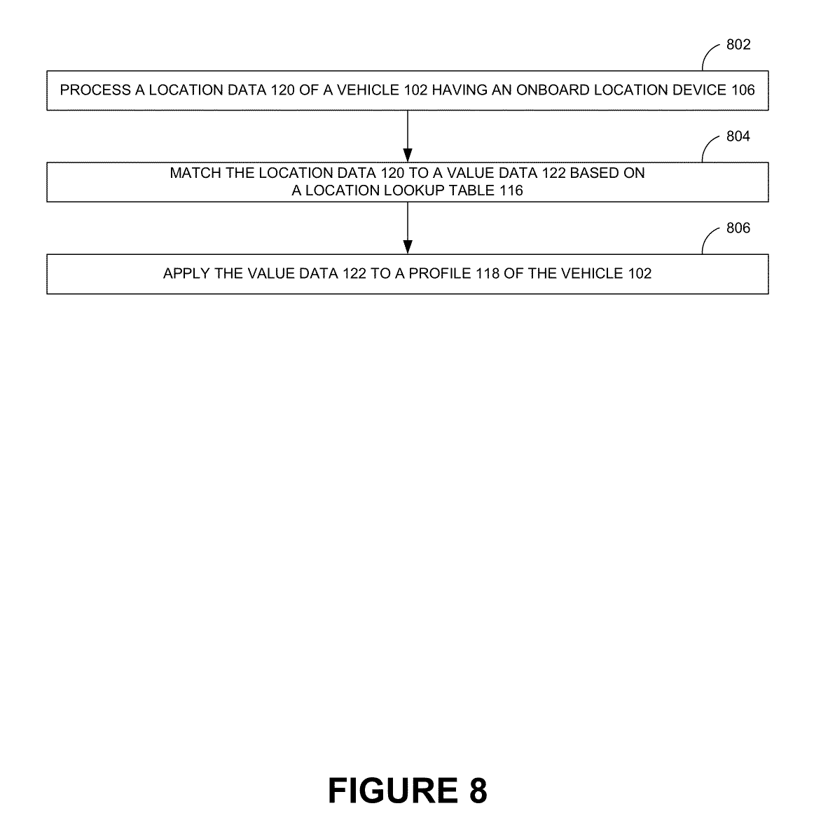

FIG. 8 is a process flow of applying the value data 122 to a profile 118 of the vehicle 102 of FIG. 1, according to one embodiment. In operation 802, a location data 120 of a vehicle 102 having an onboard location device 106 is processed. In addition, in operation 804, the location data 120 is matched to the value data 122 based on a location lookup table 116. IN operation 806, the value data 122 is applied to a profile 118 of the vehicle 102.

It can be appreciated that a method includes generating a set of geospatial boundaries associated with a region of interest 900, applying a set of rules to the geospatial boundaries 902 associated with the region of interest 900, assessing a value data 122 to a vehicle 102 having an onboard location device 106 when the vehicle 102 traverses the region of interest 900, and applying the value data 122 to a profile 118 of the vehicle 102, according to one embodiment. The method may include processing a location data 120 of the vehicle 102 having the onboard location device 106. Moreover, the method may determine that the location data 120 is in the set of geospatial boundaries associated with the region of interest 900.

FIG. 9 is a map view 950 depicting a set of geospatial boundaries around a region of interest 900 in which the vehicle 102 of FIG. 1 traverses, according to one embodiment. The map view may be generated by the administrative server and may be presented to an administrator and/or personnel with access to the administrative server. The map view may also be presented to a user 124 on a display device 400 of FIG. 4. For example, the map view 950 may illustrate the specific location of the user 124 of vehicle 102 with regard to a region of interest 900.

The map view 950 may also aid in geographically locating and tracking multiple regions of interest. The map view 950 may depict where a vehicle 102 or a plurality of vehicles is located with regard to a region of interest 900 and/or geospatial boundaries 902.

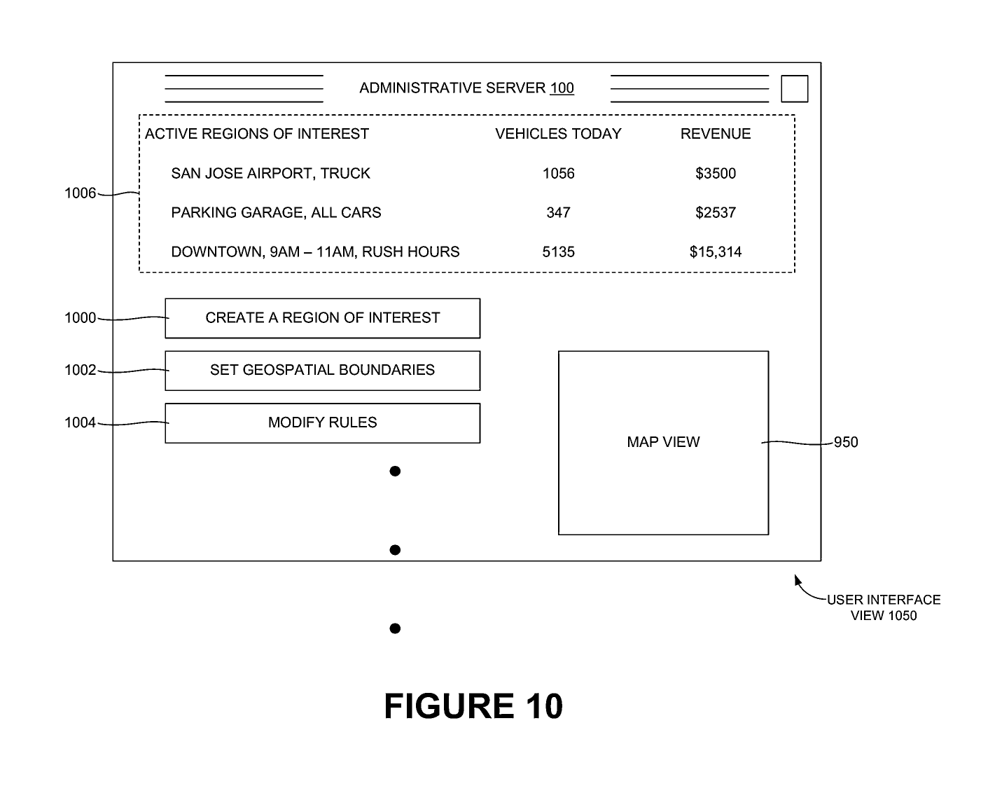

FIG. 10 is a user interface view 1050 of the administrative server 100 of FIG. 1, according to one embodiment. The user interface view 1050 may be presented to an administrator and/or personnel with access to the administrative server. For example, the user interface view 1050 may display information pertaining to active regions of interest, number of vehicles that have traversed in a region of interest, and revenue generated for a particular region of interest (collectively shown as an area 1004 in FIG. 10). The user interface view 1050 may also present administrative commands that may be executed by the administrative server 100. An administrator may create a region of interest 900 in operation 1000, set geospatial boundaries in operation 1002, and/or modify rules in operation 1004. For example, the administrator may create a region of interest 900, such as a parking garage, and may set geospatial boundaries for that region. The administrator may also modify rules (such as the modification rules 114 of a meta data 300) corresponding with the newly created region of interest 900. In addition, the administrator may be presented with a map view 950, illustrating any number of regions of interest and/or correlated to the geospatial boundaries 902 as shown in the area 1004.

An example will now be described in which the various embodiments will be explained in a hypothetical scenario. A city named ‘Anytown’ in the state of ‘Anystate’ may wish to build a new freeway to ease traffic from one portion of the city to another. To pay for their new freeway, ‘Anytown’ may wish to charge a fee for all vehicles which enter a downtown area of the city. In addition, ‘Anytown’ may want to charge a toll for all vehicles that traverse the new freeway. The state of ‘Anystate’ may have enacted a law in which all vehicles are required to install the onboard location device 106 of FIG. 1 in a manner such that the onboard location device 106 cannot easily be removed from the vehicle.

Whenever a vehicle in ‘Anytown’ enters (and/or exits) the downtown area, the onboard location device 106 of each vehicle may automatically communicate a message to an administrative server 100 of the ‘Anytown’ city. The information communicated may include things such as how long a particular vehicle was in the downtown area, what type of vehicle it was, what time of day it was when the vehicle entered etc. Based on any of these factors, Anytown may assess different fees based on financial and/or social objectives. For example, Anytown might charge more for vehicles entering the downtown area during rush hour, and may reward them when they enter during evening shopping hours.

Similarly, Anytown might charge a premium for larger vehicles that enter the downtown area. In other words, a value data 122 of each vehicle that enters the downtown ‘Anytown’ area may be modified based on a set of rules/criteria set by the government of ‘Anytown’ and/or the state of ‘Anystate’. Deploying a new toll location (or later charging tolls on the new freeway) may be easy for ‘Anytown’ because they would not need to purchase and maintain hardware and software infrastructure to periodically enable collection of tolls (e.g., electronic sensors, toll gates, etc.) because of automated communication and collection of profile information in the administrative server 100 received from onboard location devices of vehicles entering into regions of interest 900.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a machine readable medium). For example, the various electrical structure and methods may be embodied using transistors, logic gates, and electrical circuits (e.g., application specific integrated (ASIC) circuitry and/or Digital Signal Processor (DSP) circuitry).

In addition, it will be appreciated that the various operations, processes, and methods disclosed herein may be embodied in a machine-readable medium and/or a machine accessible medium compatible with a data processing system (e.g., a computer device). Accordingly, the specification and drawings are to be regarded in an illustrative in rather than a restrictive sense.

1. A method, comprising:
processing, by a processor of an administrative server, a location data received on at least one of a periodic basis and a conditional basis from an onboard location device of a vehicle;
matching, by the processor, the location data to a value data based on a location lookup table;
determining the value data based on at least one of a toll data, credit data, and cost function;
modifying the value data utilizing modification rules, dependent upon a meta data;
combining a plurality of modified value data into one of an aggregate user data, aggregate location data, and aggregate vehicle data;
communicating the modified value data to a display device associated with the vehicle,
wherein the location lookup table is configured to provide information concerning whether the vehicle is within a region of interest; and
applying, by the processor, the value data to a profile of the vehicle based on the vehicle's presence in the region of interest.

2. The method of claim 1, further comprising:
applying, by the processor, at least one of a credit and a debit, based on the value data, to a financial account of a user associated with the vehicle according to a predetermined policy of an administrator.

3. The method of claim 2, further comprising:
applying, by the processor, at least one of a credit and a debit, based on the value data, to a non-financial account of a user associated with the vehicle according to a predetermined policy of an administrator.

4. The method of claim 3, further comprising:
modifying, by the processor, the value data to a modified value data depending on at least one of a meta data comprising at least one of a time of day, a date, a vehicle type, a vehicle model, a vehicle manufacturer, a property associated with the location, a network associated with the location, a total of usage of the vehicle during a predetermined period of time, a total of carbon emissions calculated for the vehicle during a predetermined period of time, a usage pattern of the vehicle, a network associated with a user of the vehicle, a profile associated with a user of the vehicle, a number of passengers associated with the vehicle, a level of a benefits plan associated with a user, an account balance associated with a user, an occupancy data associated with the site, and an occupancy data associated with a plurality of sites associated with the network.

5. The method of claim 4, further comprising:
communicating, in real-time by the processor, the modified value data to a display device associated with the vehicle; and
presenting, by the processor, a view of the modified value data to the user associated with the vehicle.

6. The method of claim 5, further comprising:
combining, by the processor, a modified value data associated with a predetermined set of vehicles into an aggregate vehicle data;
combining, by the processor, the modified value data associated with a predetermined set of locations into an aggregate location data;
combining, by the processor, the modified value data associated with a predetermined set of users into an aggregate user data; and
generating, by the processor, a report based on the processing of at least one of the aggregate vehicle data, the aggregate location data and the aggregate user data.

7. The method of claim 6 comprising:
implementing, by the processor, an administrative task based on at least one of the aggregate vehicle data, the aggregate location data and the aggregate user data.

8. A method, comprising:
processing, by a processor of an onboard location device on at least one of a periodic basis and a conditional basis, a location data associated with a vehicle;
matching, by the processor, the location data to a value data in a location lookup table;
determining the value data based on at least one of a toll data, credit data, and cost function;
modifying the value data utilizing modification rules, dependent upon a meta data;
combining a plurality of modified value data into one of an aggregate user data, aggregate location data, and aggregate vehicle data;
communicating the modified value data to a display device associated with the vehicle,
wherein the location lookup table is configured to provide information concerning whether the vehicle is within a region of interest; and
applying, by the processor, the value data to a profile of the vehicle based on the vehicle's presence in the region of interest.

9. The method of claim 8, further comprising:
applying, by the processor, at least one of a credit and a debit, based on the value data, to a financial account of a user associated with the vehicle according to a predetermined policy of an administrator.

10. The method of claim 9, further comprising:
applying, by the processor, at least one of a credit and a debit, based on the value data, to a non-financial account of a user associated with the vehicle according to a predetermined policy of an administrator.

11. The method of claim 10, further comprising:
modifying, by the processor, the value data to a modified value data depending on at least one of a meta data comprising at least one of a time of day, a date, a vehicle type, a vehicle model, a vehicle manufacturer, a property associated with the location, a network associated with the location, a total of usage of the vehicle during a predetermined period of time, a total of carbon emissions calculated for the vehicle during a predetermined period of time, a usage pattern of the vehicle, a network associated with a user of the vehicle, a profile associated with a user of the vehicle, a number of passengers associated with the vehicle, a level of a benefits plan associated with a user, an financial account balance associated with a user, an occupancy data associated with the site, and an occupancy data associated with a plurality of sites associated with the network.

12. The method of claim 11, further comprising:
communicating, in real-time by the processor, a modified value data to a display device associated with a user of the vehicle;
generating, by the processor, a view of the modified value data; and
presenting, by the processor, the view of the modified value data to the user associated with the vehicle.

13. The method of claim 12 further comprising:
transmitting, by the processor, a modified value data to an administrative server;
combining, by the processor of the administrative server, the modified value data associated with a predetermined set of vehicles into an aggregate vehicle data;
combining, by the processor of the administrative server, the modified value data associated with a predetermined set of locations into an aggregate location data; and
combining, by the processor of the administrative server, the modified value data associated with a predetermined set of users into an aggregate user data.

14. The method of claim 13 further comprising:
implementing, by the processor of the administrative server, an administrative task based on at least one of the aggregate vehicle data, the aggregate location data and the aggregate user data.

15. A system comprising:
an administrative server configured to process a location data of a vehicle on at least one of a periodic basis and a conditional basis;
an onboard location device configured to transmit the location data of the vehicle to the administrative server on at least one of a periodic basis and a conditional basis; and
a selection module of the administrative server configured to match the location data to a value data based on a location lookup table and apply the value data to a profile of the vehicle;
wherein the value data is based on at least one of a toll data, credit data, and cost function,
wherein the value data utilized by modification rules is dependent upon a meta data,
wherein a plurality of modified value data is combined into one of an aggregate user data, aggregate location data, and aggregate vehicle data,
wherein the modified value data is communicated to a display device associated with the vehicle, and
wherein the location lookup table is configured to provide information concerning whether the vehicle is within a region of interest.

16. The system of claim 15, further comprising:
a financial transaction module of the administrative server configured to apply at least one of a credit and a debit, based on the value data, to at least one of a financial account and a non-financial account of a user associated with the vehicle according to a predetermined policy of an administrator.

17. The system of claim 16, further comprising:
a value adjustment module configured to modify the value data to a modified value data depending on at least one of a meta data comprising at least one of a time of day, a date, a vehicle type, a vehicle model, a vehicle manufacturer, a property associated with the location, a network associated with the location, a total of usage of the vehicle during a predetermined period of time, a total of carbon emissions calculated for the vehicle during a predetermined period of time, a usage pattern of the vehicle, a network associated with a user of the vehicle, a profile associated with a user of the vehicle, a number of passengers associated with the vehicle, a level of a benefits plan associated with a user, an account balance associated with a user, an occupancy data associated with the site, and an occupancy data associated with a plurality of sites associated with the network.

18. The system of claim 17, wherein the administrative server is configured to communicate, in real-time, a modified value data to a display device associated with the vehicle, and presents a view of the modified value data to a user associated with the vehicle.

19. The system of claim 18, further comprising:
an aggregation module configured to combine:
a modified value data associated with a predetermined set of vehicles into an aggregate vehicle data,
the modified value data associated with a predetermined set of locations into an aggregate location data, and
the modified value data associated with a predetermined set of users into an aggregate user data.

20. The system of claim 19 further comprising:
the aggregation module configured to generate a report based on the processing of at least one of the aggregate vehicle data, the aggregate location data and the aggregate user data.

21. A method, comprising:
generating, by a processor of an administrative server, a set of geospatial boundaries associated with a region of interest on at least one of a periodic basis and a conditional basis;
applying, by the processor, a set of rules to the geospatial boundary associated with the region of interest on at least one of a periodic basis and a conditional basis;
assessing, by the processor, a value data to a vehicle having an onboard location device when the vehicle traverses the region of interest;
determining the value data based on at least one of a toll data, credit data, and cost function;
modifying the value data utilizing modification rules, dependent upon a meta data;
combining a plurality of modified value data into one of an aggregate user data, aggregate location data, and aggregate vehicle data;
communicating the modified value data to a display device associated with the vehicle; and
applying, by the processor, the value data to a profile of the vehicle.

22. A method of claim 21 comprising:
processing, by a processor of an administrative server, a location data of the vehicle having the onboard location device;
determining, by the processor, that the location data is in the set of geospatial boundaries associated with the region of interest; and
applying, by the processor, at least one of a credit and a debit, based on the value data, to an account of a user associated with the vehicle according to a predetermined policy of an administrator.
